(19) United States
(12) Patent Application Publication
(10) Pub. No.: US 2010/0153559 A1
(43) Pub. Date: Jun. 17, 2010

(54) Method and Apparatus for Suspending Network Based Services

(75) Inventor: Loc Yu, Seattle, WA (US)

Correspondence Address: AT & T Legal Department - WS;Attn: Patent Docketing, Room 2A-207, One AT & T Way, Bedminster, NJ, 07921, US

(73) Assignee: AT&T Mobility II LLC, Atlanta, GA (US)

(21) Appl. No.: 12/337,387

(22) Filed: Dec. 17, 2008

(51) Int. Cl. G06F 15/16

(52) U.S. Cl. 709/227

(57) ABSTRACT

Disclosed is a method for de-registering user equipment from a network in response to notification that the user equipment will cease using network services. An Interruption Service Manager (ISM) notifies the network to suspend services as the IMS network conditions or the user equipment conditions change. The ISM may also notify the user equipment to re-register onto the IMS core network when the connection is re-established.

### BACKGROUND

The IP Multimedia Subsystem (IMS) is an open and standardized architecture for converged fixed and mobile communications services. IMS enables service providers to expand their offerings to their customers by integrating voice and multimedia communications, such as video, text, images and instant messages. IMS is emerging as a viable architecture that may enable the convergence of various forms of communication, including voice and data, fixed and mobile services, public hot spot and enterprise WLAN, into a system to provide the user with a seamless experience across various access networks.

The IMS core network is a collection of network elements linked by standardized interfaces, which, when grouped, form one IMS administrative network. Various IMS functions are implemented by an IMS implementer that may perform more than one function at a single network element, or may implement a single function in more than one network element. As used herein, a network element includes a logical entity which performs a network function.

Users may access an IMS network in various ways using the standard Internet Protocol (IP). Certain types of devices, such as mobile phones, personal digital assistants (PDAs) and computers may register directly onto an IMS network.

SIP provides functions needed for the establishment and maintenance of communications sessions between users. One of the functions it provides is a registration operation. A registration is a binding between a SIP Uniform Resource Identifier (URI) and one or more contact URIs. URI is the addressing technology for identifying resources on the Internet or a private intranet. A contact URI is a resource that may be contacted in order to interact with the user.

### SUMMARY

Disclosed herein is a method of de-registering user equipment from a network in response to notification that the user equipment will cease using network services. In an embodiment of the disclosed technology, the user equipment is de-registered from the network in response to an impending interruption of service either by the network or by the user equipment. This avoids the waste of network resources that occurs when user equipment that has lost network service remains registered with the network until such time as the network recognizes that there has been no activity with the user equipment for an extended period of time. In accordance with the disclosed technology, this de-registration can occur before or after interruption in network service, but this de-registration is effected based on an impending interruption in service rather than, for example, based on an extended period of inactivity that results from an interruption in service.

### BRIEF DESCRIPTION OF THE DRAWINGS

FIGS. 1 and 2 are high-level block diagrams of a network in which an embodiment may be implemented;

FIG. 3 is a flow chart of a method for de-registering a user equipment from a data network in accordance with one embodiment;

FIGS. 4A, 4B, 4C, 4D and 4E are signaling diagrams of a method for de-registering a user equipment from a data network; and

FIG. 5 is a high level block diagram of a computer that may be used in implementing an embodiment of t he disclosed technology.

### DETAILED DESCRIPTION

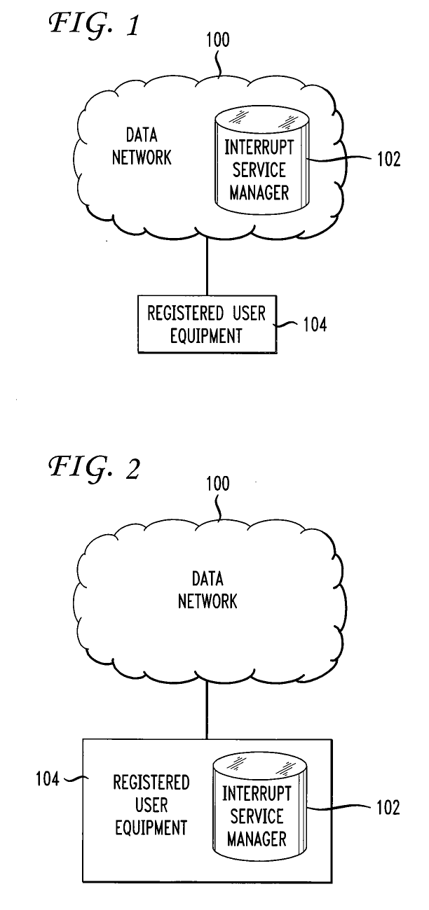

FIGS. 1 and 2 are high-level block diagrams of a network in which an embodiment of the disclosed technology may be implemented. The data network 100 may be a packet-based Internet Protocol network that is capable of merging voice, video and data communication onto a single network. An example of such a data network is an IMS/VoIP Core Network. The data network 100 serves as the initial point of contact for the registered user equipment 104. User equipment may be any device used directly by an end user to communicate. Registered user equipment is an instrument used by a client that has registered with the IMS data network. An example of registered user equipment may be a cellular phone that has the capability of registering with the IMS data network.

The Interrupt Service Manager (ISM) 102 enables clients and or servers, upon request, to be notified of network interruptions and network status changes. The ISM 102 may reside within the data network 100, as shown in FIG. 1, or within the registered user equipment 104, as shown in FIG. 2. Alternatively an ISM 102 may reside in both the data network 100 and within the registered user equipment 104.

A key issue that faces service providers who offer network based services to end users occurs when the registered user equipment loses connectivity with the data network. A disconnection between the registered user equipment and the data network may occur if a server or a network element within the data network is temporarily shut down for routine maintenance. Such a disconnection is considered to be generated by the data network.

Another type of disconnection may occur when the registered user equipment invokes a service that severs the connection between the registered user equipment and the data network. An example of such service may be Virtual Private Network (VPN). VPN is a well known in the data network industry. VPN is a secure computer network service in which the link-layer protocols of the virtual network may be tunneled through the larger network. This may cause an interruption in the connection between the registered user equipment and the data network. Such a disconnection is considered to be generated by the registered user equipment.

When the connection between registered user equipment and an exemplary IMS data network is severed, the user equipment may remain registered on the data network. Such a condition is referred to as an “orphan status” (i.e., the registered user equipment is registered onto the IMS data network but is no longer connected to the network). The registered user equipment may remain in an orphan status for several hours or longer before the data network recognizes that the user equipment is not connected to the network. In addition, registered user equipment that is in an orphan status may not realize that it is not connected to a data network and needs to re-connect and re-register on to a different data network in order to obtain services.

Orphan status may be very costly to a network because the user equipment that is in orphan status continues to be registered on the data network even though it is not connected to the network. In addition to this waste of network resources, a server within the data network may continue to attempt to send information to the registered user equipment, even though the user equipment is no longer connected to the network. Several attempts to send and re-send data may ensue, followed by multiple expirations of timeout periods. This consumes traffic bandwidth and other resources in the data network.

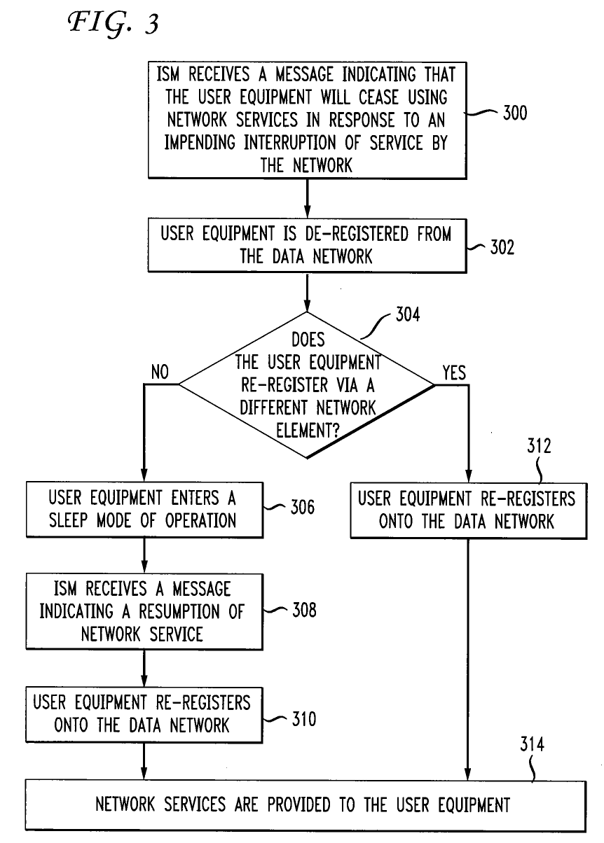

FIG. 3 is a flow chart of a method in accordance with one embodiment of the disclosed technology. The Interrupt Service Manager (ISM) 102 is adapted to send and receive messages between the data network 100 and the registered user equipment 104. These messages may be sent via SIP protocol or equivalent and authenticated by the ISM.

In step 300, the ISM receives a message indicating that the user equipment will cease using network services. This message may be in response to notification of an impending network service interruption, which may be sent by either the network or by the registered user equipment.

In response to the message received by the ISM in step 300 indicating that the user equipment will cease using network services, the registered user equipment is de-registered from the data network in step 302. Thus, the user equipment will not be in an orphan status because it is no longer registered onto the data network. This frees network resources and may also result in, or be in addition to, the freeing of user equipment resources. This step of de-registration of the registered user equipment from the network may occur before or after the interruption of network service. Next, the ISM in decision step 304 determines if the registered user equipment should re-register onto the data network via a different network element in the data network. This determination is based on several factors, including, for example, the availability of another network element through which the user equipment may re-register onto the data network, the duration of the network service interruption, and whether the user equipment or the network will generate the disconnection between the data network and the registered user equipment.

If, at decision step 304, the user equipment does not re-register onto the data network via a different network element, then the decision proceeds to step 306. This decision may result if there is not another network element for which the user equipment may re-register onto the data network, or if the duration of the network service interruption will exceed a predetermined duration. The decision may also proceed to step 306 if the user equipment causes an event that triggers the network service interruption. The predetermined duration may be greater than the duration of brief network interruptions such as system restarts, which typically may last for a few seconds. Also, if the user equipment will generate the disconnection between the data network and the registered user equipment, it may indicate that the user equipment does not wish to continue to receive services from the data network. Therefore the user equipment will not re-register with the data network via a different network element. If for these or other reasons, the user equipment will not reregister or retain its registration with the network, then a message is sent containing instructions for the registered user equipment to enter a sleep mode of operation.

As indicated, if the user equipment does not require network services, or does not re-register onto the data network via a different network element, then the ISM at step 306 sends a message instructing the user equipment to enter a sleep mode of operation. As used herein, a sleep mode of operation refers to a device setting where the network shuts down unnecessary communications with the user equipment, thereby conserving resources and bandwidth. In response to the user equipment changing status from active to sleep mode, network services to the user equipment are suspended. After the network services are resumed, the Interrupt Service Manager receives a message at step 308 indicating such a resumption of network services. Based on the message that the network services has resumed, the user equipment at step 310 is re-registered onto the data network. Thus, network services may continue to be provided to the registered user equipment at step 314 in response to the change in status of the user equipment from sleep to active mode.

If, at decision step 304, the user equipment will re-register onto the data network via a different network element, then the decision proceeds to step 312. This decision may result if there is another network element through which the user equipment will re-register onto the data network, or if the duration of the network service interruption will exceed a predetermined duration. For example, if the network interruption will be of relatively long duration, (i.e. more than several seconds), then the ISM at step 304 sends a message with instructions to re-register the user equipment onto the data network via a different network element. Based on the message, the user equipment at step 312 is re-registered onto the data network via a different network element. This process of re-registering via a different network element may be accomplished by the network providing instructions to the user equipment to re-register onto the data network. The data network will establish an alternate network element to service the user equipment. When the data network receives the request from the user equipment to re-register, the network will route the request from the network element that may be out-of-service to the established alternate network element. Thus, network services may continue to be provided to the registered user equipment at step 314.

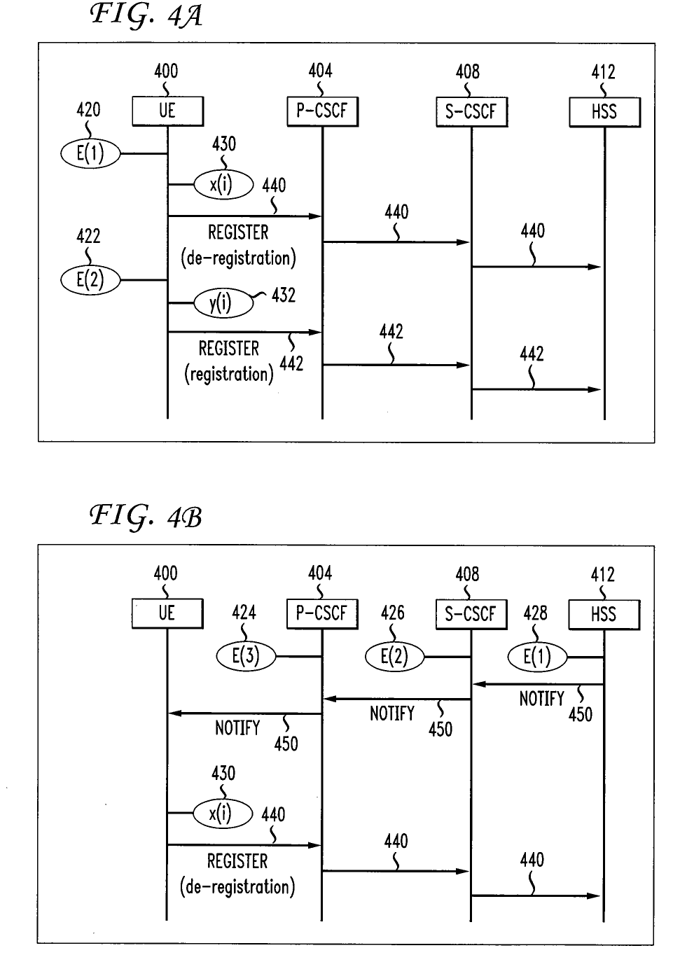

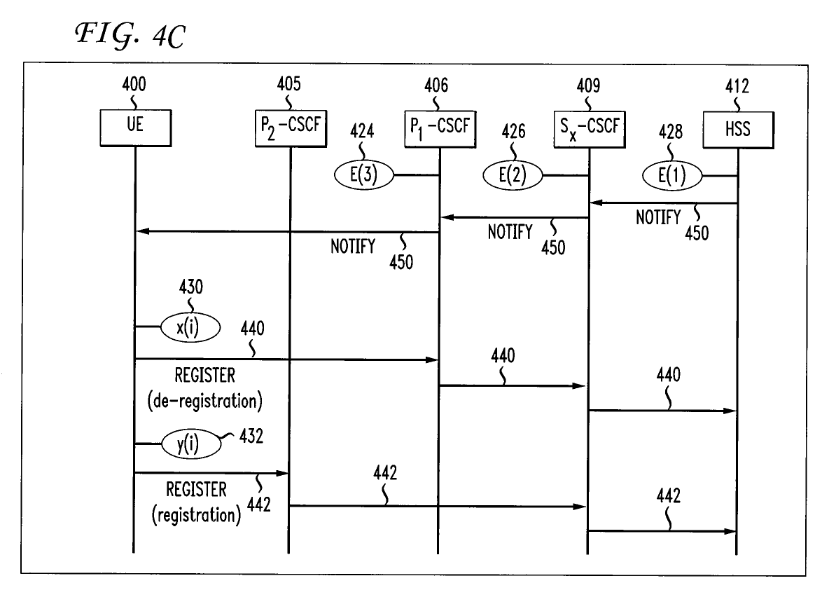

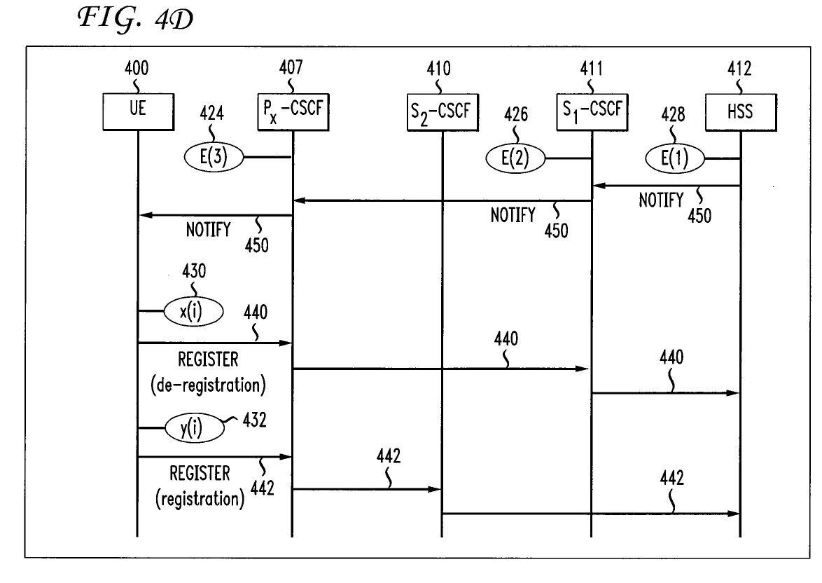

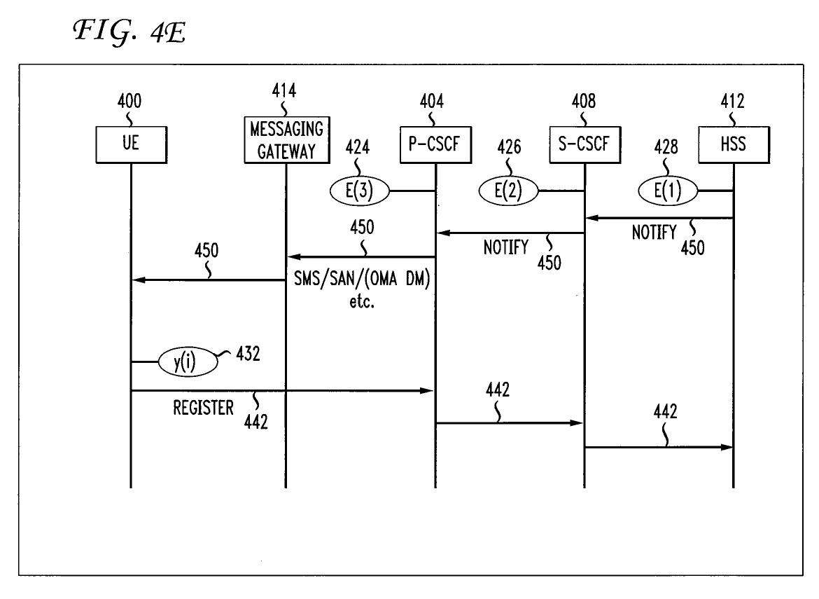

FIGS. 4A, 4B, 4C, 4D and 4E are signaling diagrams of a method for de-registering the user equipment from a data network. FIG. 4A shows a message and signaling processing diagram indicating an in-band communication as a result of which the registered user equipment 400 causes an event that triggers the network service interruption. One example of how the registered user equipment 400 may cause such a network service interruption may be when it invokes a virtual private network application, thereby causing an interruption in the connection with the data network. As shown in FIG. 4A, E(1) at 420 is the event that triggers the ISM to instruct all registered IMS services on the registered user equipment to de-register the user equipment from the data network and to go into sleep mode. The de-registration message is received by the Proxy Call Session Call Function (P-CSCF) 404. The P-CSCF 404 is an IMS network element that forwards Session Initiation Protocol (SIP) messages from the user equipment. The P-CSCF 404 serves as the initial point of contact for the user equipment into the data network. The de-registration message 440 is sent via the SIP Register message header. Each network service that is provided to the user equipment is addressed with internal actions x(i) 430. The internal actions x(i) 430 may represent a graceful shut down of network service or for the user equipment to enter a sleep mode of operation.

The de-registration message 440 may be relayed to the Serving-Call Session Control Function (S-CSCF) 408 and the Home Subscriber Server (HSS) 412, based on SIP or IMS protocols. The S-CSCF 408 is a network element that provides session control for subscribers accessing services within the IMS network. The HSS 412 stores information such as authentication profiles and user identities for the support, establishment and maintenance of calls and sessions originated by and terminated to subscribers.

E(2) at 422, as shown in FIG. 4A, is an event that indicates the resumption of network service. An example of such an event may be when the user equipment completes its VPN connection and desires to resume services with the IMS. E(2) at 422 is the event that triggers the ISM to instruct all registered IMS services on the registered user equipment 400 to resume services. In response to the event E(2) at 422, the IMS wakes up the registered IMS services on the user equipment 400 with actions y(i) 432 and sends a registration message 442, via the SIP registration header, requesting that the data network re-register the user equipment onto the data network for the resumption of data services. The registration message 442 may be relayed to the S-CSCF 408 and HSS 412, depending on whether any registered IMS services originates from the S-CSCF 408 and HSS 412, respectively. Actions y(i) 432 may include actions such as a user equipment restart or ending a sleep mode of operation to resume a normal mode of operation.

FIG. 4B shows a message and signaling processing diagram indicating in-band communication where the network causes an event that triggers the service interruption. Such an event may be a shutdown of a particular network element, thereby causing the network service interruption. E(3) at 424 is an event that is triggered by the P-CSCF 404. The ISM sends a message 450 to the registered user equipment 400, indicating an impending network interruption. In response to E(3) at 424, the IMS network services on the user equipment 400 is addressed with internal actions x(i) 430, which includes shut down and/or entering a sleep mode of operation. The ISM sends a de-registration message 440, instructing the P-CSCF 404 to de-register the user equipment 400 from the IMS services that originates from the P-CSCF 404.

E(2) at 426 is an event that is triggered by the S-CSCF 408. The ISM sends a message 450 to the registered user equipment 400, indicating an impending network interruption. In response to E(2) at 426, the IMS network services on the user equipment 400 are addressed with internal actions x(i) 430. The ISM sends a de-registration message 440 to the P-CSCF 404, which is then relayed to the S-CSCF 408 to de-register the user equipment 400 from the IMS services that originates from the S-CSCF 408. Similarly, E(1) at 428 is an event that is triggered by the HSS 412. Internal actions x(i) 430 address the IMS network services on the user equipment 400. The ISM sends a message 450 to the registered user equipment, indicating an impending network interruption. In response to receiving E(1) 428, the ISM sends a de-registration message 440 to the P-CSCF 404, which is then relayed to the S-CSCF 408 and then to the HSS 412 to de-register the user equipment 400 from the IMS services that originates from the HSS 412.

FIGS. 4C and 4D are message and signaling processing diagrams indicating in-band communication where the network induces the interruption and the user equipment re-registers onto a different network element. As shown in FIG. 4C, E(3) at 424 is an event that is triggered by the P1-CSCF 406. The ISM sends a message 450 to the registered user equipment 400, indicating in impending network interruption. In response to E(3) 424, the IMS network services on the user equipment 400 are addressed with internal actions x(i) 430. The ISM sends a de-registration message 440, instructing the P1-CSCF 406 to de-register the user equipment 400 from the IMS services that originate from the P1-CSCF 406. At the appropriate time, the ISM wakes up the IMS services on the user equipment 400 with actions y(i) 432 and sends a registration message 442, instructing the IMS network to re-register the user equipment 400 onto the network via P2-CSCF 405.

Events E(2) at 426 and E(1) at 428, as shown in FIG. 4C, may represent temporary restarts of the SX-CSCF409 and the HSS 412, respectively. The ISM sends a message 450 to the registered user equipment 400, indicating an impending network interruption. In response, the IMS network services on the user equipment 400 are addressed with internal actions x(i) 430. The ISM sends a de-registration message 440 to de-register the user equipment 400 from the IMS services. The de-registration message 440 is relayed to the SX-CSCF 409. For event E(1) at 428, the de-registration message 440 is relayed to the HSS 412. After a predetermined duration, the ISM wakes up the IMS services on the user equipment 400 with actions y(i) 432 and sends a registration message 442 to re-register the user equipment 400 onto the data network. The registration message 442 is relayed to the SX-CSCF 409. For event E(1) at 428, the registration message 442 is relayed to the HSS 412.

FIG. 4D shows a message and signaling processing diagram, similar to FIG. 4C. Event E(2) at 426 is an event that is triggered by the S1-CSCF 411. The ISM sends a message 450 to the registered user equipment 400, indicating in impending network interruption. In response to E(2) at 426, the IMS network services on the user equipment 400 are addressed with internal actions x(i) 430. The ISM sends a de-registration message 440 to the PX-CSCF 407. The de-registration message 440 is relayed to the S1-CSCF 411 to de-register the user equipment 400 from the IMS services that originates from the S1-CSCF 411. When network services are available, the ISM resumes network services with actions y(i) 432. The ISM sends a registration message 442 instructing the IMS network to re-register the user equipment 400 onto the network via S2-CSCF 410.

Events E(3) at 424 and E(1) at 428, as shown in FIG. 4D, may represent temporary restarts of a PX-CSCF 407 and HSS 412, respectively. The ISM sends a message 450 to the registered user equipment 400, indicating an impending network interruption. In response, the network services on the user equipment 400 are addressed with actions x(i) 430. The ISM sends a de-registration message 440 to de-register the user equipment 400 from the IMS services. After a predetermined duration, the ISM wakes up the network services on the user equipment 400 with actions y(i) 432 and sends a registration message 442 to re-register the user equipment 400 onto the data network.

FIG. 4E shows a message and signaling processing diagram indicating out-of-band communication where the network notifies the user equipment 400 of service resumption. Events E(3) at 424, E(2) at 426 and E(1) at 428 represent network service resumption of elements P-CSCF 404, C-CSCF 408 and HSS 412, respectively. Because the user equipment 400 was de-registered from the IMS network, the network must use an out-of-band communication 450 to indicate a resumption of service. A messaging gateway module 414 serves as a placeholder for the out-of-band communication 450. As used herein, an out-of-band communication is defined as a non-IMS communication. Such a communication may include Short Message Service (SMS), Server Alert Notification (SAN), Unstructured Supplementary Service Data (USSD) and Open mobile Alliance (OMA). In response to receiving E(3) at 424, E(2) 426 at or E(1) at 428, the IMS network services on the user equipment 400 are addressed with internal actions x(i) 430. The ISM sends a registration message 442 instructing the respective network element to re-register the user equipment 400 onto the data network.

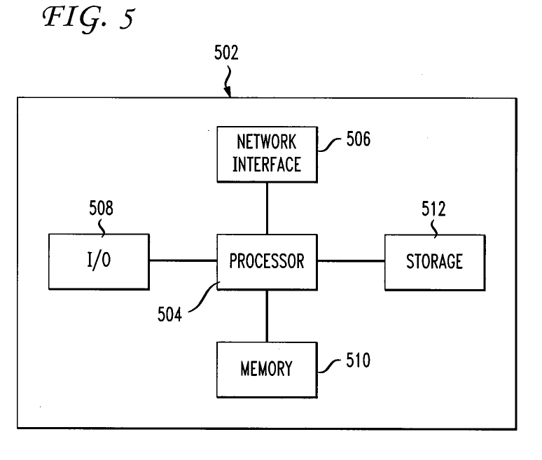

The above-described methods and network elements may be implemented using one or more computers using well-known computer processors, memory units, storage devices, computer software, and other components. A high level block diagram of such a computer is illustrated in FIG. 5. Computer 502 contains a processor 504 which controls the overall operation of the computer 502 by executing computer program instructions which define such operation. The computer program instructions may be stored in a storage device 512, or other computer readable medium (e.g., magnetic disk, CD ROM, etc.), and loaded into memory 510 when execution of the computer program instructions is desired. Thus, the steps of FIGS. 3 and 4A-E can be defined by the computer program instructions stored in the memory 510 and/or storage 512 and controlled by the processor 504 executing the computer program instructions. For example, the computer program instructions can be implemented as computer executable code programmed by one skilled in the art to perform an algorithm defined by the steps of FIGS. 3 and 4A-E. Accordingly, by executing the computer program instructions, the processor 504 executes an algorithm defined by the steps of FIGS. 3 and 4A-E. The computer 502 also includes one or more network interfaces 506 for communicating with other devices via a network. The computer 502 also includes other input/output devices 508 that enable user interaction with the computer 502. One skilled in the art will recognize that an implementation of an actual computer could contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for de-registering a user equipment from a network comprising:
de-registering the user equipment from the network in response to notification that the user equipment will cease using network services.

2. The method of claim 1 wherein the user equipment will cease using network services in response to an impending interruption of service by the network.

3. The method of claim 1 wherein de-registering includes freeing network resources that will not be used when the user equipment ceases using network services.

4. The method of claim 1 wherein de-registering includes freeing user equipment resources that will not be used when the user equipment ceases using network services.

5. The method of claim 1 wherein the network sends to the user equipment notification of an impending interruption in network services.

6. A method for placing a user equipment in a sleep mode comprising:
suspending services to the user equipment in response to an impending change in the status of the user from active to sleep mode; and
reestablishing services to the user equipment in response to an impending change in the status of the user equipment from sleep to active mode.

7. The method of claim 2 further comprising:
in response to determining that a duration of the interruption will exceed a predetermined duration, sending a message containing instructions for the registered user equipment to re-register to the data network via a different element.

8. The method of claim 1 further comprising:
in response to determining if a duration of the interruption will exceed a predetermined duration, sending a message containing instructions for the registered user equipment to enter a sleep mode of operation.

9. An apparatus for de-registering a user equipment from a network comprising:
means for de-registering the user equipment from the network in response to notification that the user equipment will cease using network services.

10. The apparatus of claim 9 wherein the user equipment will cease using network services in response to an impending interruption of service by the network.

11. The apparatus of claim 9 wherein de-registering includes freeing network resources that will not be used when the user equipment ceases using network services.

12. The apparatus of claim 9 wherein de-registering includes freeing user equipment resources that will not be used when the user equipment ceases using network services.

13. The apparatus of claim 9 wherein the network sends to the user equipment notification of an impending interruption in network services.

14. An apparatus for placing a user equipment in a sleep mode comprising:
means for suspending services to the user equipment in response to an impending change in the status of the user from active to sleep mode; and
means for reestablishing services to the user equipment in response to an impending change in the status of the user equipment from sleep to active mode.

15. The apparatus of claim 10 further comprising:
means for sending a message containing instructions for the registered user equipment to re-register to the data network via a different element in response to determining that a duration of the interruption will exceed a predetermined duration.

16. The apparatus of claim 9 further comprising:
means for sending a message containing instructions for the registered user equipment enter a sleep mode of operation in response to determining if a duration of the interruption will exceed a predetermined duration.

17. A computer readable medium encoded with computer executable instructions for de-registering a user equipment from a network, the computer executable instructions comprising:
de-registering the user equipment from the network in response to notification that the user equipment will cease using network services.

18. The computer readable medium of claim 17 wherein the user equipment will cease using network services in response to an impending interruption of service by the network.

19. The computer readable medium of claim 17 wherein de-registering includes freeing network resources that will not be used when the user equipment ceases using network services.

20. The computer readable medium of claim 17 wherein de-registering includes freeing user equipment resources that will not be used when the user equipment ceases using network services.

21. The computer readable medium of claim 17 wherein the network sends to the user equipment notification of an impending interruption in network services.

22. A computer readable medium encoded with computer executable instructions for placing a user equipment in a sleep mode, the computer executable instructions comprising:
suspending services to the user equipment in response to an impending change in the status of the user from active to sleep mode; and
reestablishing services to the user equipment in response to an impending change in the status of the user equipment from sleep to active mode.

23. The computer readable medium of claim 18, wherein the instructions further comprise:
in response to determining that a duration of the interruption will exceed a predetermined duration, sending a message containing instructions for the registered user equipment to re-register to the data network via a different element.

24. The computer readable medium of claim 17 wherein the instructions further comprise:
in response to determining if a duration of the interruption will exceed a predetermined duration, sending a message containing instructions for the registered user equipment enter a sleep mode of operation.
